(19) United States
(12) Patent Application Publication
(10) Pub. No.: US 2011/0142554 A1
(43) Pub. Date: Jun. 16, 2011

(54) CONTAINER FOR USE IN PNEUMATIC TRANSPORT SYSTEM

(76) Inventor: Robert Terzini, Corinth, TX (US)

(21) Appl. No.: 13/059,974

(22) PCT Filed: Aug. 22, 2009
(86) PCT No.: PCT/US09/54710

§ 371 Date: Feb. 19, 2011

(30) Foreign Application Priority Data
Aug. 22, 2008 (US) 61/090900
Nov. 10, 2008 (US) 61/112776

(51) Int. Cl. B65G 51/04

(52) U.S. Cl. 406/189; 406/184; 406/190

(57) ABSTRACT

In a pneumatic container transport system, specialized cylindrical containers move between processing stations through cylindrica conduits propelled by low-pressure, high-velocity air. Annular ridges around the circumference of the containers minimize contact with the inside conduit walls and deter scuffing of labels which carry machine-readable indicia upon which the container transport system relies for directing the containers. In a preferred embodiment, the containers are bottles having a coaxial mouth closed by threaded caps, the caps still preferably including a transparent window to allow visual and spectroscopy analysis of the bottle contents. In an alternate embodiment, the containers are longitudinally symmetrical clamshells for irregularly shaped objects, the clamshells opening through a longitudinal mouth along one side and sealable with tamper-proof labels.

of which the following is a specification. This application is a continuation-in-part of, and claims priority to, a U.S. Provisional Application Ser. No. 61/090,900, filed Aug. 22, 2008. This application also claims priority to U.S. Provisional Application Ser. No. 61/112,776, filed Nov. 10, 2008.

### BACKGROUND OF THE INVENTION

1. Field of the Invention

This invention relates generally to automated pharmaceutical distribution systems and particularly to container transport systems for use in prescription filling systems. More particularly, this invention relates to a container for transporting small objects through tubing from one station to another through a pneumatic transport system.

2. Description of Related Art

In automated prescription filling systems, bottle handling requires transporting the bottles while tracking their exact location and status. In a preferred system, individually labeled prescription bottles move through pneumatic conduit or tubing impelled by low-pressure, high velocity air. Such bottles necessarily engage the inside walls of such conduits, especially when rounding corners, and they abruptly may stop when reaching their destination. Not only can their labels become scuffed from contact with conduit walls, but the labels can shift out of position on the outside bottle walls due to abrupt stopping. A need exists for a specialized bottle adapted for high-speed movement through tubular conduits without causing scuffing or shifting of its labels.

Though prescription filling systems can be largely automated by standardizing prescription containers, labeling, certification, packaging and shipping, many prescription products do not lend themselves to such handling. For example, unlike pharmaceutical pills, some prescription products comprise creams, ointments, salves and liquids, often in irregularly shaped manufacturers' containers, while others comprise syringes, applicators, inhalers, gauges and the like, nonel of which can be handled in standardized pill counters nor move through a pneumatic transport system in their own manufacturer's packaging. A need exists for a container that enables such irregularly shaped objects to be through pneumatic tubing and otherwise as necessary to provide them with the same security and automated handling as for such products as bulk pills and capsules.

### SUMMARY OF THE INVENTION

In a pneumatic container transport system, specialized cylindrical containers move between processing stations through cylindrical conduits propelled by low-pressure, high-velocity air. Annular ridges around the circumference of the containers minimize contact with the inside conduit walls and deter scuffing of labels which carry machine-readable indicia upon which the container transport system relies for directing the containers. In a preferred embodiment, the containers are bottles having a coaxial mouth closed by threaded caps, the caps preferably also include a transparent window to allow visual and spectroscopy analysis of the bottle contents. In an alternate embodiment, the containers are longitudinally symmetrical clamshells for irregularly shaped objects, the clamshells opening through a longitudinal mouth along one side and sealable with tamper-proof labels. In both embodiments, one end of the container may include a recess adapted to receive a RFID device in lieu of the machine-readable indicia on the labels.

### BRIEF DESCRIPTION OF THE DRAWINGS

The novel features believed characteristic of the present invention are be set forth in appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 shows in quartering perspective view an automated prescription filling system utilizing the pneumatic bottle transport system of the present invention.

FIG. 2 depicts the automated prescription filling system of FIG. 1 in top plan view.

FIG. 3 shows in side elevational view one channel of the bottle transport system FIG. 1.

FIGS. 4A-4D detail a preferred embodiment of a bottle used in the container transport system of FIG. 1.

FIG. 4E shows a bottle of FIGS. 4A-4D packaged for shipping.

FIGS. 4F-4I depict a pre-filling of the bottles of FIGS. 4A-4D and labeling with a contents label for inventory.

FIGS. 5A-5G detail an alternate embodiment of a clamshell container also used in the container transport system of FIG. 1.

FIG. 6 demonstrates the clamshell of FIGS. 5A-5G in use in the transport system of FIG. 1.

### DESCRIPTION OF A PREFERRED EMBODIMENT

NOTE: hereinafter, the present invention is discussed in the context of a container transport system dedicated to filling pharmaceutical prescriptions, primarily into prescription bottles for most pill and capsule-like pharmaceuticals, or into clamshell containers for irregular objects. One having ordinary skill in the art will recognize that other types of containers having similar features may be substituted and still considered to be within the spirit and scope of the present invention.

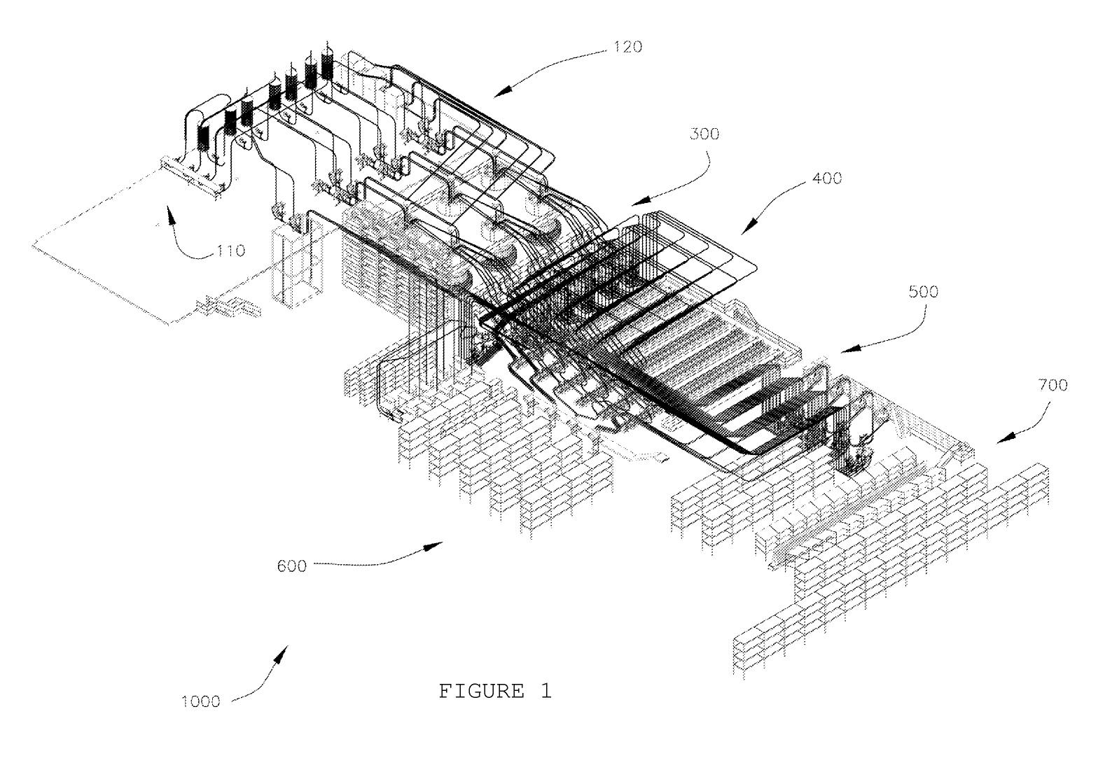

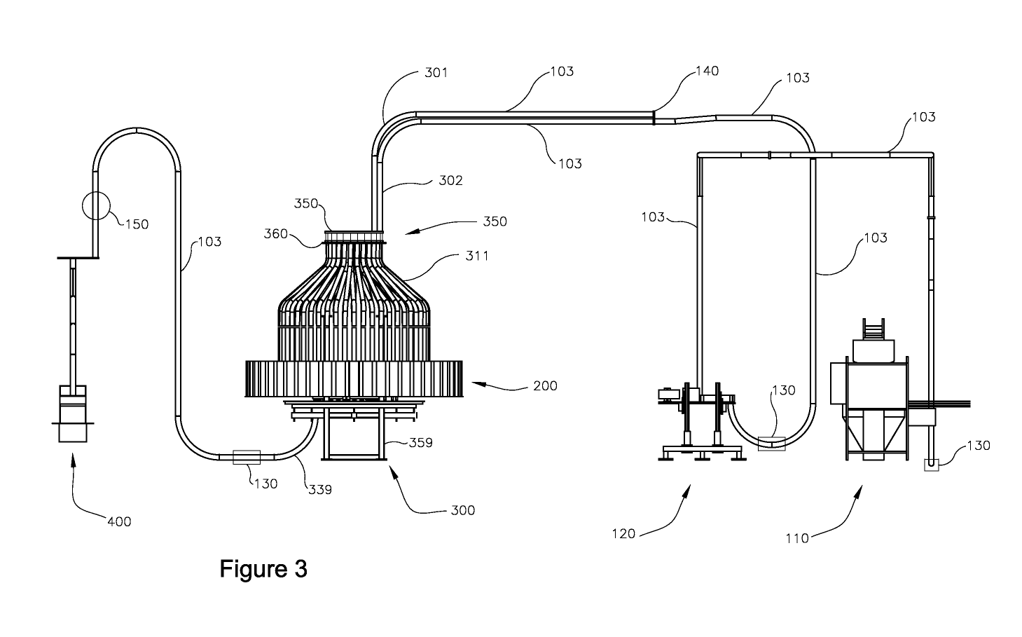

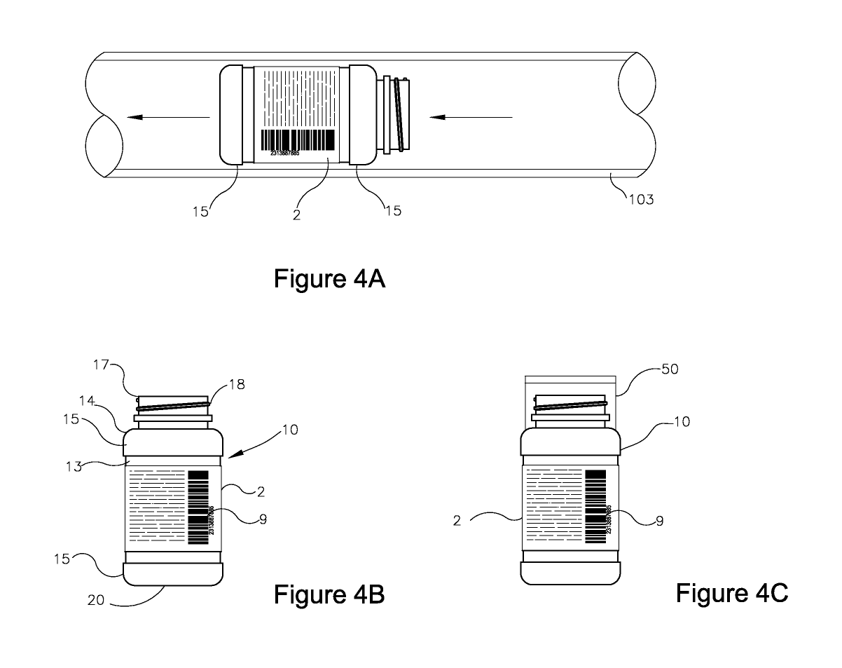

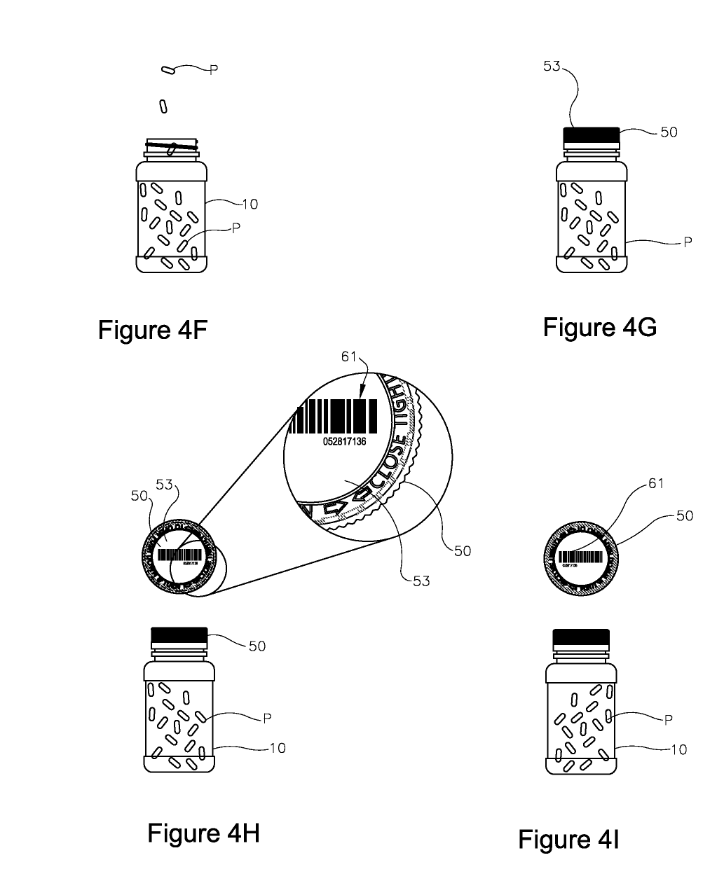

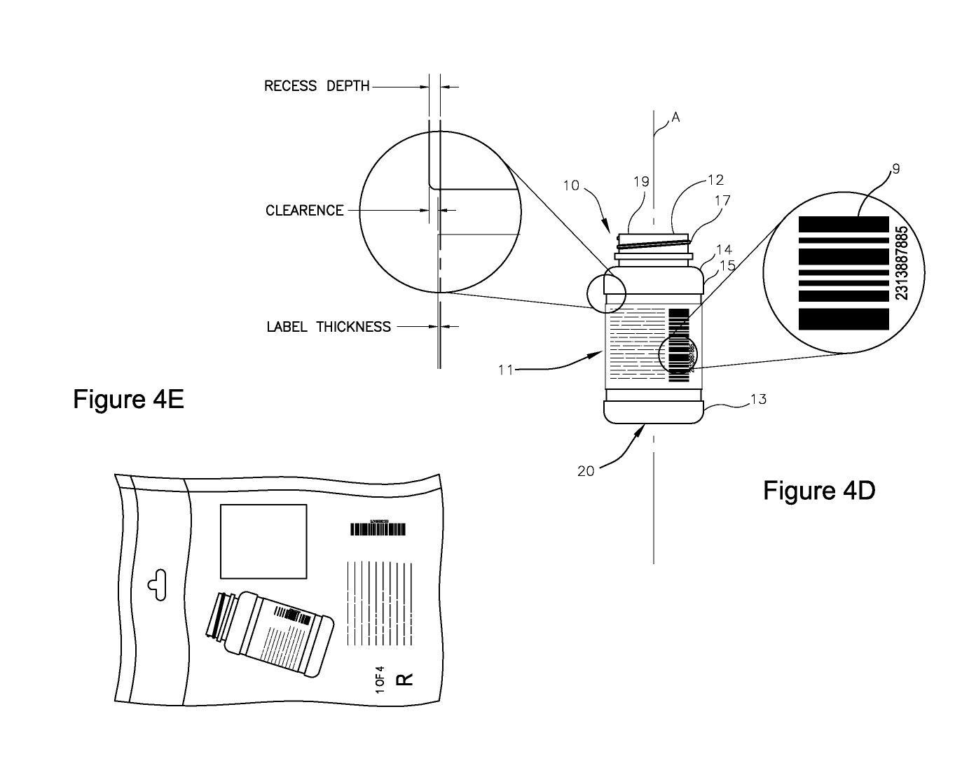

Referring now to the figures, and particularly to FIGS. 1-3, automated prescription filling system 1000 comprises prescription dispensing apparatus 300 feeding filled prescription bottles 10 (see FIG. 4A-4D) through prescription verification stage 400 and sortation conveyor system 500 to bagging, packaging and shipping system 600 where filled prescriptions are conveyed through common carriers to pharmacies, hospitals and individual patients (collectively “customers”). Apparatus 300 comprises a stage where pre-labeled containers 10 are filled according to each individual prescription from an array of individual pharmaceutical dispensing machines 200 and sealed by automated capping system 160. Containers 10 then are transported to verification stage 400 where a pharmacist confirms that each container 10 contains the pharmaceutical required. Apparatus 700 comprises automated storage of containers 40 (discussed in detail below) and pre-filled, unlabeled containers 10 inventoried for collation with containers 10 filled in dispenser station 300. Containers 10, 40 then are transported to conveyor 500 where they are accumulated with others for the same customer before being packaged (see FIG. 4E) at stage 600 and shipped, all without requiring human hands to handle containers 10 or their pharmaceutical contents.

Pharmaceutical dispensing machines 200, prescription dispensing apparatus 300, prescription verification system 400, sortation conveyor system 500, container 10 and prescription autopackaging system 600 all are the subject matter of related but separate patent applications. This application is for containers adapted to travel through the container transport system 100 to one or more if its various processing stages of system 1000 and which may be used independently for other such systems or purposes.

### Prescription Bottles and Bottle Induction, Labeling and Transport

Turning now to FIGS. 4A-4D, container 10 comprises a regular, generally cylindrical bottle having walls 11 surrounding and concentric about longitudinal axis A and defining interior 12 into which a plurality of pharmaceuticals P (see FIGS. 4F-4H) may be introduced by dispenser units 200. Other than at ridges, or rings 15, bottle 10's diameter remains substantially uniform along axis A between bottom 20 and shoulders 14. Bottle 10 is closed at bottom 20 opposite shoulders 14 where it reduces to neck 17 bearing threads 18 adapted to mate with cylindrical cap 50 which closes and seals bottle 10. Though larger than neck 17, cap 50's diameter remains slightly smaller than that of walls 11 to remain within the profile of bottle 10 to pass through pneumatic tubes 103 for transportation between stations of system 1000.

Disposed between shoulders 14 and bottom 20, annular recess 13 slightly reduces the outside diameter of bottle 10 between upper and lower rings 15 to accommodate label 2. Label 2 bears indicia 9 comprising a bar code or other machine readable encoding adapted to inform prescription filling system 1000 and its various sensors and software (not shown), through use of a dynamically populated database, of the contents and expected location of bottle 10 within prescription filling system 1000. Recess 13 offsets label 2 from the full diameter of bottle 10, leaving only annular rings 15 adjacent bottom 20 and shoulder 14 to contact tubing 101 (FIG. 1). This prevents label 2 from becoming scuffed, torn, abraded or smeared, and from sliding out of place, while bottle 10 speeds through system 1000 and is abruptly stopped, rotated, translated and otherwise jostled.

Dispensing stations 300, containing an array of dispenser units 200 each dedicated to a single pharmaceutical P, are capable of counting out exact numbers of pharmaceuticals P into bottles 10. Where a patient's prescription calls for a fixed number of such pharmaceuticals P, bottles 10 are inducted empty into system 1000 at station 110 (FIG. 1), labeled accordingly at labelers 120, filled at dispensing stations 300 and capped with caps 50. Caps 50 have transparent window 54 within their tops 51 to facilitate verification and certification stations 400 where their contents are verified through window 54. Bottles 10 so filled with a specific patient's prescription then move to sortation system 500 to be collated with other bottles 10 or containers 40 (discussed below) before being shipped to the patient or his customer pharmacy.

Dispensing stations 300 also can be used to fill bottles 10 to capacity, or to a standard quantity of pharmaceuticals P for bulk inventory and distribution. As seen in FIGS. 4F-4I, bottles 10 are filled (FIG. 4F) with pharmaceuticals P and closed with cap 50, as described above, except that no patient-specific prescription label 2 has been placed within label space 13. Patient labeling occurs later when bottle 10 is selected and packaged (FIG. 4E) for a customer's order. Bottles 50 then are closed using caps 50 and forwarded to certification stations 400 where their contents are verified and certified as with patient specific bottles 10. Within stations 400, a round, opaque label 53 bearing product bar code 61 is tamped onto top 51 to identify the contents of bottle 10 and to certify that they have been verified at station 400.

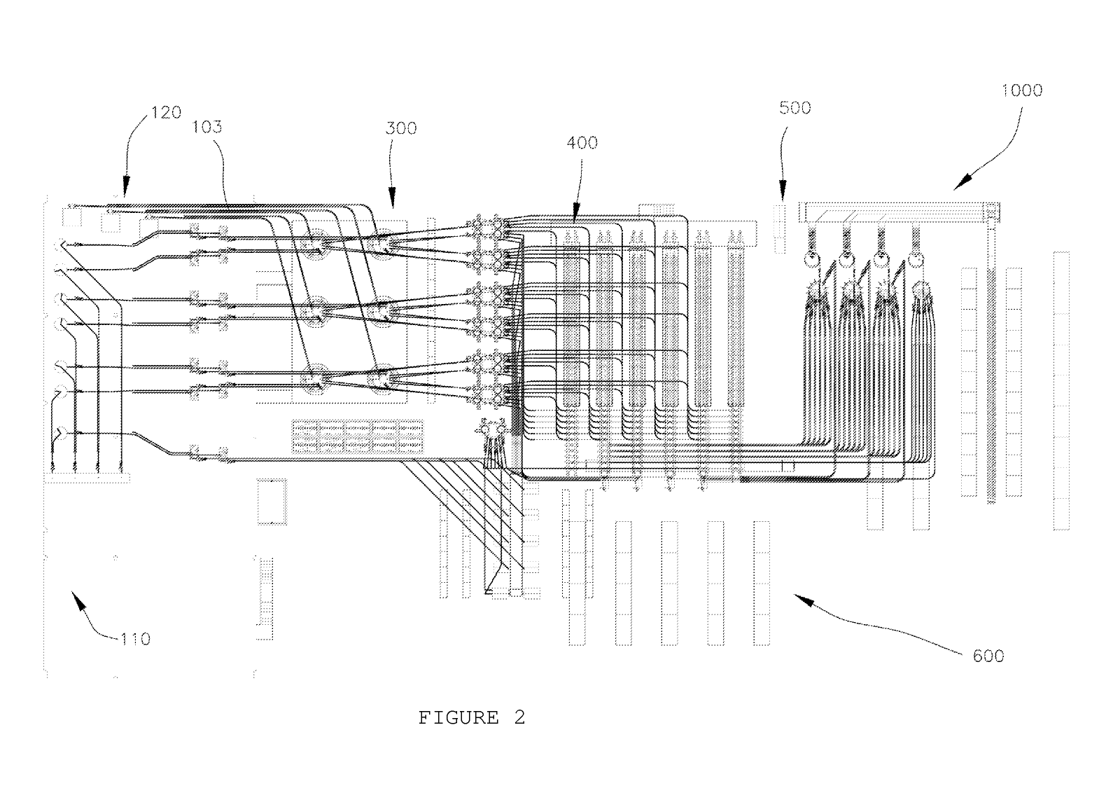

Bottles 10 so filled, certified and bar-coded also are not forwarded immediately to sortation station 500. Instead, a large quantity of bottles 10 pre-filled with a given pharmaceutical P will be certified and bar-coded and then accumulated for inventory. Such inventory is stored at inventory storage station 700 (FIG. 2) until needed to fill a particular customer's order.

Bottles 10 preferably are made from high-impact polypropylene fabricated using an injection molding a process. One having ordinary skill in the art will recognize, however, that other materials may be suitable for bottles 10 as long as they maintain dimensional stability and remain relatively light in weight so that their mass is comparatively nominal in contrast to the mass of their contents.

For containers 10 described herein with the preferred embodiment, bottles 10 have an outside diameter of two (2″) inches and are approximately four (4″) inches long, including their caps installed onto neck 17 and mated with threads 18. One having ordinary skill in the art will recognize that bottles 10 could be considerably larger or smaller as required in an alternate embodiment or application.

### Clamshell Containers

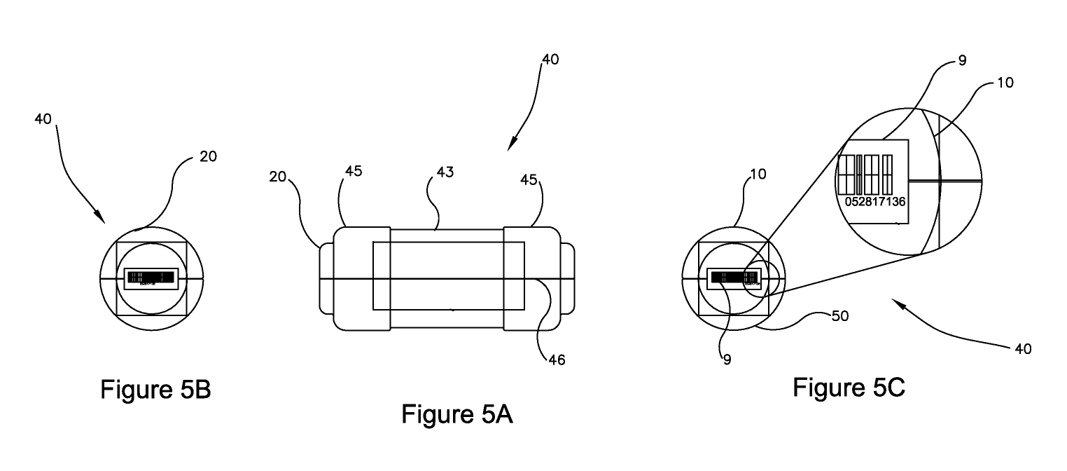

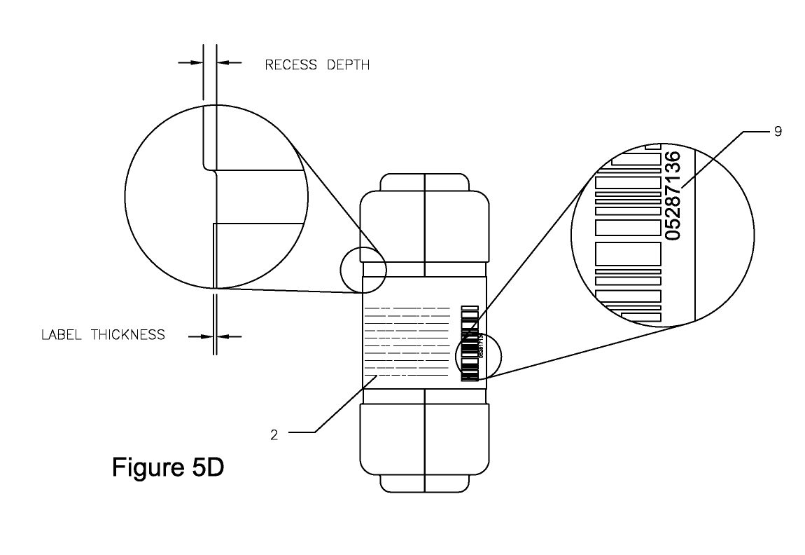

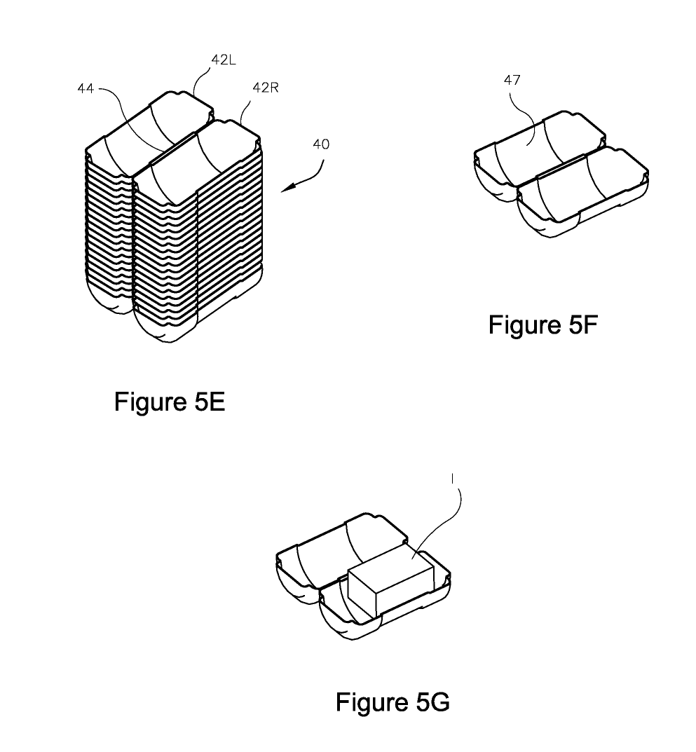

Turning now to FIGS. 5A-5G, an alternate pharmaceutical container for system 1000 comprises clamshell 40 adapted to contain irregularly shaped and sized products I which cannot be dispensed into bottles 10 at dispensing stations 300. Instead of being closed at bottle 20 and sealed with cap 50 like bottle 10, clamshell 40 comprises two half cylinders 42L, 42R (FIG. 4D) coupled at one of their longitudinal edges by hinge 44 such that halves 42L, 42R may close together at mouth 46 to form clamshell interior 47 for containing products I.

In similar fashion to bottle 10, clamshell 40 includes top and bottom rings 45 adapted to pass slidably through pneumatic transport tubes 103 with minimal friction. Rings 45 also define patient label space 43, slightly recessed from the outside diameter of rings 45 so that patient labels 2 placed thereon will remain stationary instead of sliding out of place due to contact with tubes 103 or under the impetus of sudden stops, turns and the like while moving through tubes 103.

Also in similar fashion as pre-filled bottles 10, patient labels 2 are not placed onto clamshells 40 when they are filled with product I. Instead, product I is placed within interior 47 and mouth 46 and clamshell 40 closed and locked. Then, two product labels 48 are placed, one on each end 41 and across mouth 46, thereby sealing clamshell 40 to be tamper-evident. Labels 48 also bear product specific bar codes 61 to identify contents I of clamshell 40. Product bar codes 61 later may be scanned to assure that the expected content of clamshell 40 is present when mating clamshell 40 with a specific patient's prescription, as described on patent label 2 bearing prescription bar code 63, is to be applied within label space 43.

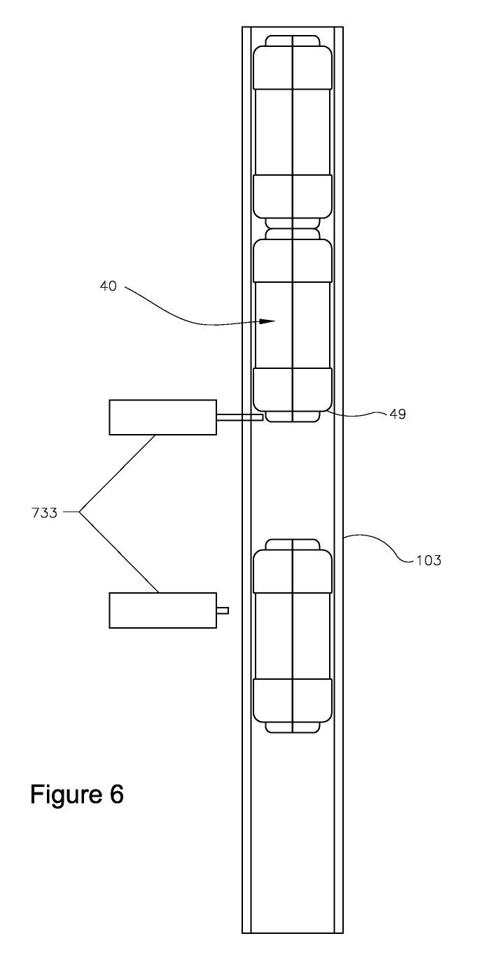

FIG. 5D illustrates another desirable feature of clamshell 40. Rings 45 form shoulders 49 opposite label space 43, whereby end 41 has a reduced radius compared with the rest of clamshell 40. Shoulders 49 provide a ready rest for gating mechanism 733 (FIG. 6). A plurality of clamshells 40 may be stacked vertically and held by gate 733 by two actuators 733A, 733B which engage shoulders 49 to control admission of clamshells 40 to the next stage of operation of system 1000. Specifically, when bottom clamshell 40 is ready to move downward, upper actuator 733A closes to engage lower shoulder 49 of clamshell 40 next in line, thus holding the entire column of clamshells 40. Lower actuator 733B then opens to drop bottom clamshell 40. Once bottom clamshell 40 has cleared gate 733, lower actuator 733B closes again and upper actuator 733A opens to permit another clamshell 40 to enter gate 733 and ready for the next stage.

One having ordinary skill in the art will recognize that bottles 10 also may progress through gate 733 in similar fashion, and without reliance upon shoulders 49. However, whereas bottles 10 must be oriented such that their bottoms 20 enter gate 733 first, as well as being so oriented throughout system 1000 so pharmaceuticals P may be introduced through neck 17, clamshell 40 can be oriented in either direction within tubes 103, at least until patient label 2 is applied.

Also as with pre-filled bottles 10, a large quantity of clamshells 40 will be filled at once with a particular product I and set aside for inventory. Once filled and marked with product bar code 61, clamshells 40 are transported to clamshell storage area 701 (FIG. 2) to await being introduced into sortition stage 500.

Though clamshell 40 has been discussed herein above as transportable through tubing 103 as though it moves through areas of system 1000 common to bottle 10, necessarily limiting clamshells 40 to geometric dimensions approximating bottles 10 (e.g inside diameter of tubing 103, and design radii of curved portions of tubing 103). One having ordinary skill in the art will recognize, however, that clamshells 40 are not limited to being sized similarly to bottles 10, but may have their own separate system of transport. Clamshells 40 may come in a variety of sizes adapted to contain irregular objects I of a wide range of sizes, concomitantly using tubes 103 of corresponding size. Further, though discussed herein as movable through pneumatic tubing 103, clamshells 40 also could be transported on conveyor belts or other means for moving them within transport system 1000.

While the invention has been particularly shown and described with reference to preferred and alternate embodiments, it will be understood by those skilled in the art that various changes in form and detail may be made therein without departing from the spirit and scope of the invention. For example, though containers transport system 1000 has been presented herein in the context of prescription filling for pharmaceuticals, it easily could be adapted to any inventory management system dispensing containers of small objects, such as screws, nuts or other fasteners. Container 10 has been described as a bottle having dimensions appropriate to the preferred embodiment of a pharmaceutical prescription-filling application, but it could be considerably larger or smaller as required, either in similar pharmaceutical prescription filling systems or in other applications.

I claim:

1. A container for use in a pneumatic container transport system, the transport system having a plurality of container processing stations coupled together by pneumatic tubing coupled to air impellers which use air to move said containers between processing stations, the container comprising
a cylindrical body having a body diameter and a longitudinal axis extending between a bottom and a top, said body surrounding an interior;
at least two annular ridges surrounding and coaxial with said body, one each of said at least two annular ridges being disposed adjacent said top and bottom, each annular ridge having a ridge diameter exceeding said body diameter;
an annular recess surrounding said body between said ridges and having a recess diameter exceeded by said ridge diameters of said at least two annular ridges; and
closure means for closing said body to secure said interior.

2. The container according to claim 1 and further comprising
labeling means disposed on said cylindrical body within said annular recess and bearing machine-readable indicia adapted to direct said container through said transport system.

3. The container according to claim 1 wherein said container comprises
a bottle having
its bottom closed permanently;
a coaxial mouth disposed at said top opposite said closed bottom, said mouth surrounded by threads; and
a cap adapted to mate with said threads to close said interior.

4. The container according to claim 3 wherein
said cap surrounds and defines a coaxial cap aperture communicating with said interior;
a substantially planar membrane spanning said cap aperture, said membrane being transparent for permitting inspection of contents of said bottle within said interior.

5. The container according to claim 1 wherein said container body comprises
a mated pair of cups, each cup surrounding and defining a longitudinally disposed opening having a perimeter adapted to mate with the perimeter of the other one of said mated pair of cups to enclose and seal said interior;
hinge means coupled to said perimeter and adapted to hingedly couple said mated pair of cups together such that they are adapted to articulate between an open position and a closed position;
sealing means for sealing said mated pair of cups together in said closed position.

6. The container according to claim 5 wherein said annular ridges further comprise
a shoulder disposed at each of said bottom end and said top end of said body, said shoulder adapted to cooperate with gating within said transport system for controlling movement of said containers.

7. A pharmaceutical container adapted to be transported through a pneumatic container transport system, the transport system having a plurality of container processing stations coupled together by pneumatic tubing coupled to air impellers which use air to move said pharmaceutical containers between processing stations, the pharmaceutical container comprising
a body having longitudinal axis extending between a first end and a second end and surrounding an interior, said body further having
a first region adjacent each of said first end and second end and having a first region diameter;
a second region disposed between said first regions and having a second region diameter exceeded by said first region diameter;
access means for accessing said interior; and
closure means for closing said access means to secure said interior.

8. The pharmaceutical container according to claim 7 wherein said annular ridges further comprise
a shoulder disposed at each of said bottom end and said top end of said body, said shoulder adapted to cooperate with gating within said transport system for controlling movement of said containers.

9. The method according to claim 7 wherein
said pharmaceutical container comprises a bottle having a removable top; and
said closure means comprises a top adapted to mate with a coaxial mouth on said top, said mouth closably communicating with said interior.

10. An improved method of moving small objects between processing station of a pneumatic transport system, the transport system having a plurality of pneumatic conduits coupling together said processing stations, said pneumatic conduits having air impellers adapted to inject high-speed, low pressure air into said conduits directed from one processing station toward another to move a plurality of containers introduced into said conduits between processing stations, the method comprising
providing the container having
a cylindrical body having a body diameter and a longitudinal axis extending between a bottom and a top, said body surrounding an interior;
at least two annular ridges surrounding and coaxial with said body, one each of said at least two annular ridges being disposed adjacent said top and bottom, each annular ridge having a ridge diameter exceeding said body diameter;
an annular recess surrounding said body between said ridges and having a recess diameter exceeded by said ridge diameters of said at least two annular ridges; and
closure means for closing said body to secure said interior;
providing label means disposed on said body within said annular recess, said label means bearing machine-readable indicia for permitting said pneumatic transport system to direct said containers from one processing station to another; then
operating the transport station to
(a) introduce said container into one of said conduits at a first processing station; then
(b) direct said container along a select path between said first processing station and a second processing station; and
(c) injecting high-speed, low pressure air into said conduits to impel said container through said conduit until said container arrives at said second processing station; then
(d) repeating steps (a)-(c), inclusive, for each additional container.

11. The method according to claim 10 wherein
said container comprises a bottle having a removable top; and
said closure means comprises a top adapted to mate with a coaxial mouth on said top, said mouth closably communicating with said interior.
